(19) United States
(12) Patent Application Publication
(10) Pub. No.: US 2023/0024381 A1
(43) Pub. Date: Jan. 26, 2023

(54) UTILITY POLE DEGRADATION DETECTION SYSTEM, UTILITY POLE DEGRADATION DETECTION METHOD, AND UTILITY POLE DEGRADATION DETECTION DEVICE

(71) Applicant: NEC Corporation, Minato-ku, Tokyo (JP)

(72) Inventors: YOSHIAKI SAKAE, Tokyo (JP); Hiroki Tagato, Tokyo (JP); Kazuhiko Isoyama, Tokyo (JP); Jun Nishioka, Tokyo (JP); Yuji Kobayashi, Tokyo (JP)

(73) Assignee: NEC Corporation, Minato-ku, Tokyo (JP)

(21) Appl. No.: 17/790,904

(22) PCT Filed: Jan. 22, 2020
(86) PCT No.: PCT/JP2020/002132

§ 371 Date: Jul. 5, 2022

(51) Int. Cl. H02G 1/02; G01H 9/00; G01D 5/353

(52) U.S. Cl. CPC H02G 1/02; G01H 9/004; G01D 5/35341

(57) ABSTRACT

A utility pole degradation detection system according to the present disclosure includes: a sensing optical fiber (10) laid on a plurality of utility poles (30); a receiving unit (201) that receives vibration information detected by the sensing optical fiber (10); an identifying unit (202) that identifies a natural frequency of each of the plurality of utility poles (30) on the basis of the vibration information; and an analyzing unit (203) that analyzes a degradation state of at least one utility pole (30) among the plurality of utility poles (30) on the basis of a natural frequency of each of the plurality of utility poles (30).

### TECHNICAL FIELD

The present disclosure relates to a utility pole degradation detection system, a utility pole degradation detection method, and a utility pole degradation detection device.

### BACKGROUND ART

Conventionally, detection of abnormality in a utility pole has been often performed manually, for example, by an operator determining an abnormality only by visual inspection or determining an abnormality by a sound caused by hitting the utility pole or the like. However, manually detecting an abnormality in a utility pole takes a lot of cost and time, and may cause discovery and handling of the abnormality to be delayed.

Therefore, recently, a system for monitoring an abnormality in a utility pole by using an optical fiber has been proposed (for example, Patent Literatures 1 and 2).

In a technique described in Patent Literature 1, an optical fiber is laid linearly or spirally in the vertical direction of a utility pole. When a utility pole breaks due to a collision of an automobile, a large bend occurs in the optical fiber, and loss occurs in an optical signal propagated inside the optical fiber. Therefore, an amount of loss due to the loss is detected by optical time-domain reflectometry (OTDR) measurement, thereby detecting occurrence of breakage in any of a plurality of utility poles.

In a technique described in Patent Literature 2, a nest building detection core wire being an optical fiber for detecting a nest built on a utility pole is laid. When the nest building detection core wire is bent by a nest built on the utility pole, distortion such as bending or tension occurs in the nest building detection core wire, and intensity of an optical signal propagated inside the nest building detection core wire is attenuated. Therefore, an amount of loss due to the attenuation is detected by OTDR measurement, thereby detecting that a nest has been built on the utility pole.

### CITATION LIST

### Patent Literature

[Patent Literature 1] Japanese Unexamined Patent Application Publication No. 2008-067467

[Patent Literature 2] Japanese Unexamined Patent Application Publication No. 2015-053832

### SUMMARY OF INVENTION

### Technical Problem

Incidentally, in the techniques described in Patent Literatures 1 and 2, detection of abnormality in a utility pole is performed by monitoring an amount of loss of an optical signal when strong stress is applied to an optical fiber.

Therefore, although it is possible to detect an extreme state such as nest building or breakage on the utility pole, there is a problem that it is difficult to detect a state, such as degradation of the utility pole, which hardly affects stress on the optical fiber.

Therefore, an object of the present disclosure is to solve the above-mentioned problem and provide a utility pole degradation detection system, a utility pole degradation detection method, and a utility pole degradation detection device that are capable of detecting a degradation state of a utility pole with high accuracy.

### Solution to Problem

A utility pole degradation detection system according to one aspect includes:

a sensing optical fiber laid on a plurality of utility poles; a receiving unit configured to receive vibration information detected by the sensing optical fiber;

an identifying unit configured to identify a natural frequency of each of the plurality of utility poles, based on the vibration information; and

an analyzing unit configured to analyze a degradation state of at least one utility pole among the plurality of utility poles, based on a natural frequency of each of the plurality of utility poles.

A utility pole degradation detection method according to one aspect is a utility pole degradation detection method performed by a utility pole degradation detection system, and includes:

a receiving step of receiving vibration information detected by a sensing optical fiber laid on a plurality of utility poles;

an identifying step of identifying a natural frequency of each of the plurality of utility poles, based on the vibration information; and

an analyzing step of analyzing a degradation state of at least one utility pole among the plurality of utility poles, based on a natural frequency of each of the plurality of utility poles.

A utility pole degradation detection device according to one aspect includes:

a receiving unit configured to receive vibration information detected by a sensing optical fiber laid on a plurality of utility poles;

an identifying unit configured to identify a natural frequency of each of the plurality of utility poles, based on the vibration information; and

an analyzing unit configured to analyze a degradation state of at least one utility pole among the plurality of utility poles, based on a natural frequency of each of the plurality of utility poles.

### Advantageous Effects of Invention

According to the above-mentioned aspects, a utility pole degradation detection system, a utility pole degradation detection method, and a utility pole degradation detection device that are capable of detecting a degradation state of a utility pole with high accuracy can be provided.

### BRIEF DESCRIPTION OF DRAWINGS

FIG. 1 is a diagram illustrating a configuration example of a utility pole degradation detection system according to a first example embodiment.

FIG. 2 is a diagram illustrating an example of contents of a correspondence table held by an identifying unit according to the first example embodiment.

FIG. 3 is a flow chart illustrating an example of a flow of the overall operation of the utility pole degradation detection system according to the first example embodiment.

FIG. 4 is a block diagram illustrating a configuration example of a utility pole degradation detection device according to a second example embodiment.

FIG. 5 is a diagram illustrating an example of contents of a utility pole DB according to the second example embodiment.

FIG. 6 is a diagram illustrating an example of a clustering operation performed by a clustering unit according to the second example embodiment.

FIG. 7 is a diagram illustrating an example of contents of a standard natural frequency DB according to the second example embodiment.

FIG. 8 is a flow chart illustrating an example of a flow of an operation of calculating a feature having a high contribution rate to the natural frequency in a utility pole degradation detection system according to the second example embodiment.

FIG. 9 is a flow chart illustrating an example of a flow of an operation of calculating a standard natural frequency for each cluster in the utility pole degradation detection system according to the second example embodiment.

FIG. 10 is a flow chart illustrating an example of a flow of an operation of analyzing a degradation state of a utility pole to be analyzed in the utility pole degradation detection system according to the second example embodiment.

FIG. 11 is a block diagram illustrating an example of a hardware configuration of a computer that implements the utility pole degradation detection device according to the example embodiment.

### DESCRIPTION OF EMBODIMENTS

Hereinafter, example embodiments of the present disclosure will be described with reference to the drawings. Note that the following description and the drawings are omitted and simplified as appropriate for clarity of description. In the following drawings, the same elements are denoted by the same reference signs, and repetitive descriptions thereof are omitted as necessary.

### First Example Embodiment

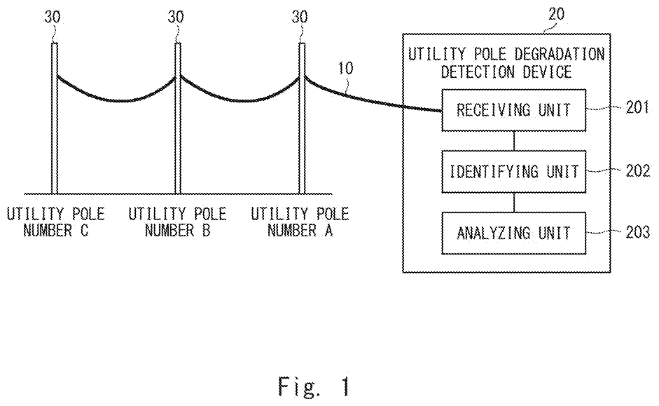

First, with reference to FIG. 1, a configuration example of a utility pole degradation detection system according to the first example embodiment will be described. In FIG. 1, three utility poles 30 are illustrated for simplification of description, but the number of utility poles 30 may be any number of two or more. It is also assumed that the three utility poles 30 illustrated in FIG. 1 have utility pole numbers A, B, and C, respectively.

As illustrated in FIG. 1, the utility pole degradation detection system according to the first example embodiment includes a sensing optical fiber 10 and a utility pole degradation detection device 20. The utility pole degradation detection device 20 includes a receiving unit 201, an identifying unit 202, and an analyzing unit 203.

The sensing optical fiber 10 is laid on a plurality of utility poles 30 (three utility poles 30 in FIG. 1). The sensing optical fiber 10 may be laid on each of the plurality of utility poles 30 in the form of a cable formed by covering one or more sensing optical fibers 10. The sensing optical fiber 10 may be an existing communication optical fiber or a newly installed optical fiber.

The receiving unit 201 inputs pulsed light into the sensing optical fiber 10, and receives, via the sensing optical fiber 10, reflected light and scattered light generated when the pulsed light is transmitted through the sensing optical fiber 10 as return light (optical signal).

Herein, the utility pole 30 vibrates more or less under the influence of natural vibration of the ground, automobiles running in the vicinity, winds, and the like. The vibration of the utility pole 30 is transmitted to the sensing optical fiber 10, and the characteristics (e.g., wavelength) of the return light transmitted through the sensing optical fiber 10 changes. Therefore, the sensing optical fiber 10 is able to detect vibration information indicating vibration generated in the utility pole 30. In addition, the return light transmitted through the sensing optical fiber 10 includes vibration information of the utility pole 30 detected by the sensing optical fiber 10, since the characteristics of the return light change depending on the vibration information of the utility pole 30 detected by the sensing optical fiber 10.

The vibration information of the utility pole 30 indicates a pattern that dynamically fluctuates, which is an inherent vibration pattern in which the intensity of vibration, the vibration position, transition of frequency fluctuation, and the like are different. Therefore, by analyzing the dynamic change of the vibration pattern of the utility pole 30 indicated by the vibration information, the identifying unit 202 is able to identify the natural frequency of such utility pole 30.

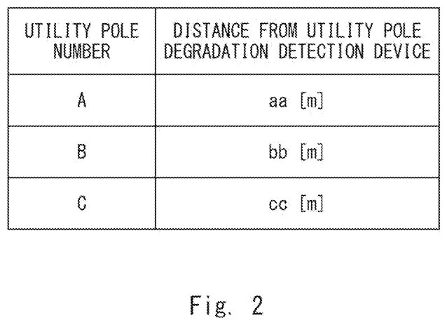

For each of the plurality of utility poles 30, the identifying unit 202 holds in advance a correspondence table in which the utility pole number of each of the plurality of utility poles 30 and positional information (positional information indicating a distance from the utility pole degradation detection device 20) are associated with each other. FIG. 2 illustrates an example of the contents of the correspondence table.

Further, the identifying unit 202 is capable of identifying at which position (distance from the utility pole degradation detection device 20) on the sensing optical fiber 10 the return light is generated based on, for example, a time difference between when the receiving unit 201 transmits the pulsed light to the sensing optical fiber 10 and when the receiving unit 201 receives the return light, the intensity of the return light received by the receiving unit 201, and the like.

Therefore, the identifying unit 202 is capable of identifying in which utility pole 30 the return light is generated by comparing the position on the sensing optical fiber 10 at which the return light is generated with the correspondence table illustrated in FIG. 2.

The identifying unit 202 identifies the return light generated in each of the plurality of utility poles 30 from the return light received by the receiving unit 201, and identifies the natural frequency of each of the plurality of utility poles 30, based on the vibration information included in the identified return light.

Herein, when the utility pole 30 is degraded due to occurrence of cracks, internal corrosion, or the like, the natural frequency thereof decreases. Therefore, the analyzing unit 203 is able to analyze the degradation state of at least one utility pole 30 among the plurality of utility poles 30, based on the natural frequency of each of the plurality of utility poles 30.

At this time, the analyzing unit 203 may analyze the degradation state of at least one utility pole 30 among the plurality of utility poles 30, based on the distribution information indicating the distribution of the natural frequency of each of the plurality of utility poles 30. For example, when there is a utility pole 30 the natural frequency of which is decreased as compared with other utility poles 30, the analyzing unit 203 is able to analyze that the utility pole 30 with the decreased natural frequency is degraded.

Each of the plurality of utility poles 30 has unique features (for example, a type of installation road surface on which the utility poles 30 is installed, the material, density, thickness, length, and depth of soil covering of the utility pole 30, the type, thickness, and number of wires supported by the utility pole 30, and the like). Therefore, it is considered that the natural frequencies of the utility poles 30 differ depending on the features of the utility poles 30.

Therefore, the analyzing unit 203 may cluster the plurality of utility poles 30 into clusters, based on the features of each of the plurality of utility poles 30, and analyze, based on the distribution information of the natural frequency of each of one or more utility poles 30 belonging to the same cluster, the degradation state of at least one utility pole 30 belonging to the cluster. As a result, the degradation state of each of the utility poles 30 belonging to the cluster can be analyzed based on the distribution of the natural frequencies of the utility poles 30 while eliminating the influence of the features of the utility poles 30, thereby the analysis accuracy of the degradation state of the utility poles 30 can be improved.

However, it is considered that features of the utility pole 30 include a feature having a high contribution rate to the natural frequency and a feature having a low contribution rate to the natural frequency. Therefore, it is considered that the analysis accuracy of the degraded state of the utility pole 30 can be further improved by performing clustering in such a way that utility poles 30 having similar features having a high contribution rate to the natural frequency belong to the same cluster.

The analyzing unit 203 may identify, from among the features of the utility pole 30, a feature having a high contribution rate to the natural frequency, and may cluster the plurality of utility poles 30 into clusters, based on the identified features of each of the plurality of utility poles 30. As a result, it is possible to further improve the analysis accuracy of the degraded state of the utility pole 30. Note that, as a method of identifying, from among the features of the utility pole 30, a feature having a high contribution rate to the natural frequency, for example, a method of calculating contribution rates of features of the utility pole 30 to the natural frequency by performing multiple regression analysis or the like may be considered, but the present invention is not limited thereto.

When analyzing the degradation state of the utility pole 30, it is considered preferable to analyze the degradation state by comparing the natural frequency with the natural frequency of a healthy utility pole 30 (e.g., a newly installed utility pole 30, etc.).

Therefore, the analyzing unit 203 may hold health information indicating the healthiness of each of the plurality of utility poles 30. Then, the analyzing unit 203 may analyze, based on the distribution information of the natural frequency of each of the one or more healthy utility poles 30 belonging to the same cluster, the degradation state of at least one utility pole 30 belonging to the cluster. More specifically, the analyzing unit 203 may calculate, based on the distribution information of the natural frequency of each of the one or more healthy utility poles 30 belonging to the same cluster, a standard natural frequency which is a standard natural frequency of the healthy utility poles 30 belonging to the cluster, and may analyze, based on the standard natural frequency of the cluster and the natural frequency of a utility pole 30 to be analyzed belonging to the cluster, the degradation state of the utility pole 30 to be analyzed. As a result, it is possible to further improve the analysis accuracy of the degraded state of the utility pole 30.

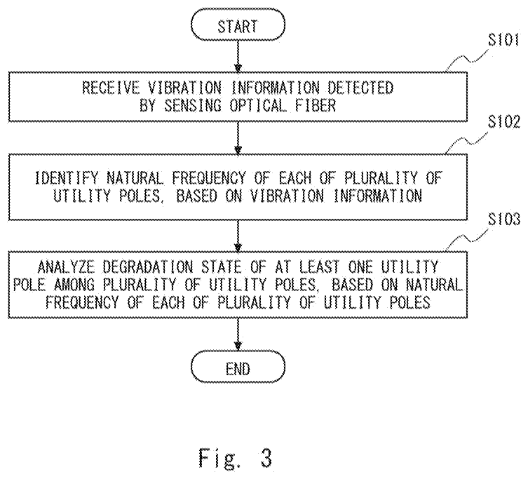

Next, with reference to FIG. 3, an example of a flow of the overall operation of the utility pole degradation detection system according to the first example embodiment will be described.

As illustrated in FIG. 3, the receiving unit 201 receives, from the sensing optical fiber 10, return light including vibration information detected by the sensing optical fiber 10 (step S101).

Then, the identifying unit 202 identifies the natural frequency of each of the plurality of utility poles 30, based on the vibration information included in the return light received by the receiving unit 201 (step S102).

Thereafter, the analyzing unit 203 analyzes the degradation state of at least one utility pole 30 among the plurality of utility poles 30, based on the natural frequency of each of the plurality of utility poles 30 identified by the identifying unit 202 (step S103).

As described above, according to the first example embodiment, the receiving unit 201 receives the vibration information detected by the sensing optical fiber 10, the identifying unit 202 identifies the natural frequency of each of the plurality of utility poles 30, based on the vibration information, and the analyzing unit 203 analyzes the degradation state of at least one utility pole 30 among the plurality of utility poles 30, based on the natural frequency of each of the plurality of utility poles 30. Therefore, the degradation state of the utility pole 30 can be detected with high accuracy.

Further, according to the first example embodiment, degradation states of the plurality of utility poles 30 can be analyzed simultaneously and remotely using the sensing optical fiber 10, thereby making it possible to easily grasp the degradation states of the utility poles 30 and to reduce the cost for grasping the degradation states of the utility poles 30.

Further, according to the first example embodiment, an existing communication optical fiber can be used as the sensing optical fiber 10. In this case, in order to detect the degradation state of the utility pole 30, only the existing communication optical fiber is required, and it is not necessary to lay an optical fiber linearly or spirally in the vertical direction of the utility pole as in Patent Literature 1, or to lay a nest building detection core wire as in Patent Literature 2. Therefore, since a dedicated structure for detecting the degradation state of the utility pole 30 is not required, the utility pole degradation detection system can be constructed inexpensively.

Further, according to the first example embodiment, an optical fiber sensing technique using the sensing optical fiber 10 as a sensor is used. Therefore, advantages such as no influence of electromagnetic noise, no need for power supply to a sensor, excellent environmental tolerance, and easy maintenance can be obtained.

### Second Example Embodiment

A utility pole degradation detection system according to the second example embodiment is a more specific embodiment of the utility pole degradation detection system according to the first example embodiment described above. Specifically, the utility pole degradation detection system according to the second example embodiment is obtained by replacing the utility pole degradation detection device 20 of the first example embodiment described above with a utility pole degradation detection device 20A, and the external system configuration is similar to that of the first example embodiment described above.

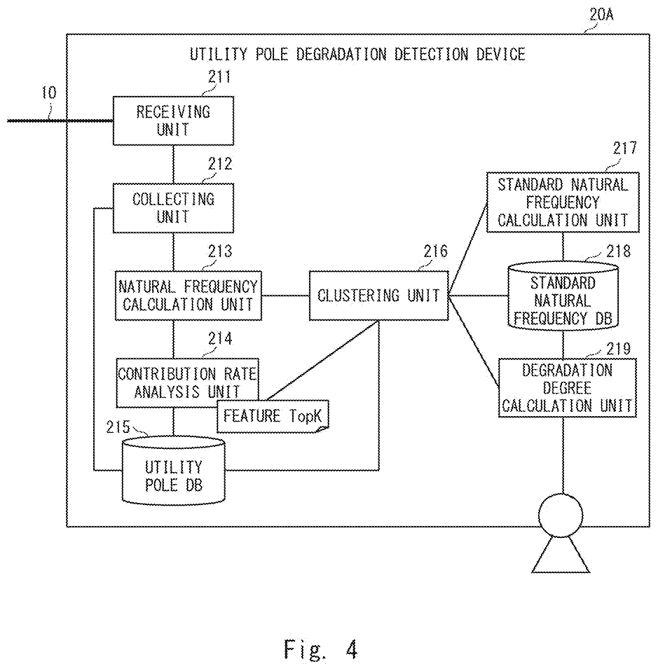

Hereinafter, with reference to FIG. 4, a configuration example of the utility pole degradation detection device 20A according to the second example embodiment will be described. Note that it is assumed that a sensing optical fiber 10 illustrated in FIG. 4 is laid on a plurality of utility poles 30 in a similar manner as in the first example embodiment described above.

As illustrated in FIG. 4, the utility pole degradation detection device 20A according to the second example embodiment includes a receiving unit 211, a collecting unit 212, a natural frequency calculation unit 213, a contribution rate analysis unit 214, a utility pole database (DB) 215, a clustering unit 216, a standard natural frequency calculation unit 217, a standard natural frequency DB 218, and a degradation degree calculation unit 219.

Herein, the receiving unit 211 corresponds to the receiving unit 201 in FIG. 1. A combination of the collecting unit 212 and the natural frequency calculation unit 213 corresponds to the identifying unit 202 in FIG. 1. A combination of the contribution rate analysis unit 214, the utility pole DB 215, the clustering unit 216, the standard natural frequency calculation unit 217, the standard natural frequency DB 218, and the degradation degree calculation unit 219 corresponds to the analyzing unit 203 in FIG. 1.

The receiving unit 211 inputs pulsed light to the sensing optical fiber 10, and receives, via the sensing optical fiber 10, reflected light and scattered light generated when the pulsed light is transmitted through the sensing optical fiber 10 as return light. The return light received by the receiving unit 211 includes return light generated in each of the plurality of utility poles 30. Each of the return lights includes vibration information indicating vibration generated in the related utility pole 30.

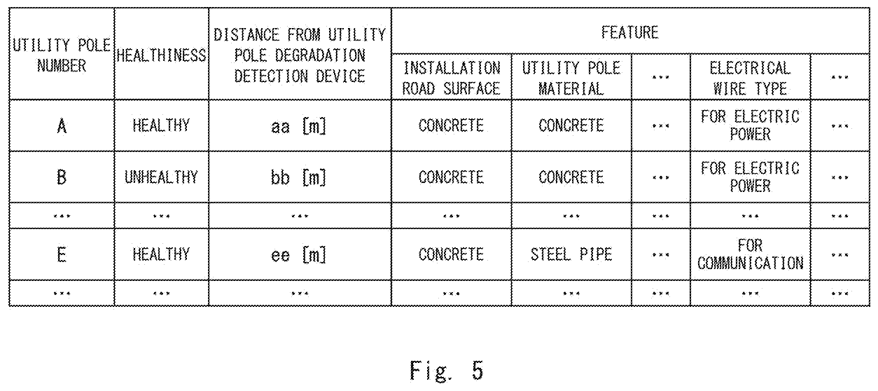

The utility pole DB 215 is a database in which the utility pole number of the utility pole 30, health information indicating the healthiness of the utility pole 30, positional information of the utility pole 30 (positional information indicating the distance from the utility pole degradation detection device 20A), and features of the utility pole 30 (for example, the type of installation road surface on which the utility pole 30 is installed, the material, density, thickness, length, and depth of soil covering of the utility pole 30, the type, thickness, and number of electrical wires supported by the utility pole 30, etc.), and the like are registered for each of the plurality of utility poles 30 on which the sensing optical fiber 10 is laid. FIG. 5 illustrates an example of the contents of the utility pole DB 215.

The collecting unit 212 collects vibration information included in the return light received by the receiving unit 211.

The collecting unit 212 is capable of identifying at which position (distance from the utility pole degradation detection device 20A) on the sensing optical fiber 10 a return light is generated, based on, for example, a time difference between when the receiving unit 211 transmits the pulsed light to the sensing optical fiber 10 and when the receiving unit 201 receives the return light, the intensity of the return light received by the receiving unit 211, and the like.

In the utility pole DB 215, as described above, the utility pole number and the positional information of the utility pole 30 are registered for each of the plurality of utility poles 30.

Therefore, by comparing the position on the sensing optical fiber 10 at which the return light is generated with the utility pole DB 215, the collecting unit 212 is able to identify which utility pole 30 the return light is generated in. Therefore, the collecting unit 212 is able to collect vibration information of the identified utility pole 30.

Note that, the collecting unit 212 is not limited to the use of the utility pole DB 215. For example, the collecting unit 212 may retain the correspondence table as illustrated in FIG. 2 according to the first example embodiment, and use such correspondence table in order to identify which utility pole 30 the return light is generated in.

The natural frequency calculation unit 213 calculates the natural frequency of the utility pole 30, based on the vibration information of the utility pole 30 collected by the collecting unit 212. The vibration information of the utility pole 30 collected by the collecting unit 212 indicates a vibration pattern unique to the utility pole 30, which is a vibration pattern that dynamically fluctuates. Therefore, the natural frequency calculation unit 213 is able to calculate the natural frequency of the utility pole 30 by analyzing the dynamic change of the vibration pattern of the utility pole 30.

The contribution rate analysis unit 214 calculates a feature Top K having a high contribution rate to the natural frequency from the features of the utility pole 30 registered in the utility pole DB 215, and holds the calculated feature Top K. The feature Top K may include only one feature, or may include a plurality of features. As a method of calculating the feature Top K performed by the contribution rate analysis unit 214, for example, a method of performing multiple regression analysis and calculating the contribution rates of features of the utility pole 30 to the natural frequency and the like may be considered. However, the calculation method of the feature Top K is not limited to the above.

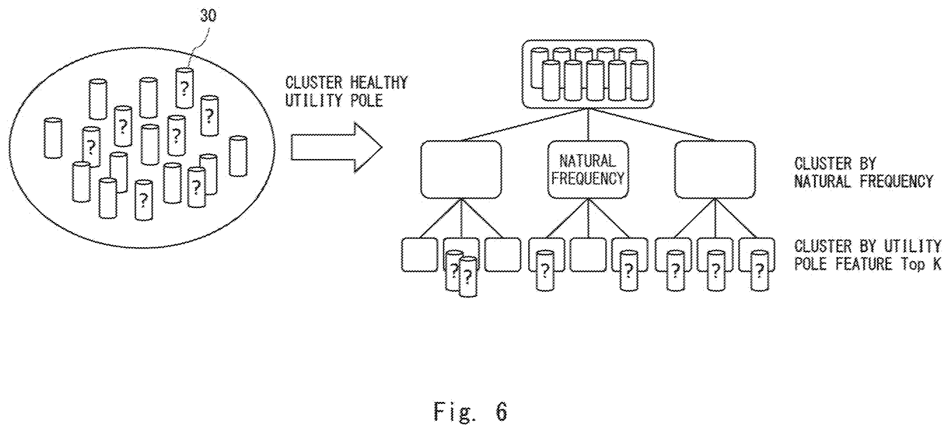

The clustering unit 216 clusters one or more healthy utility poles 30 among the plurality of utility poles 30 on which the sensing optical fiber 10 is laid into clusters. The concept of this clustering operation is illustrated in FIG. 6. As illustrated in FIG. 6, the clustering unit 216 first clusters the one or more healthy utility poles 30 into clusters, based on the natural frequency calculated by the natural frequency calculation unit 213, and further clusters the clustered one or more healthy utility poles 30 into clusters, based on the feature Top K calculated by the contribution rate analysis unit 214.

The standard natural frequency calculation unit 217 statistically calculates, for each cluster clustered by the clustering unit 216, a standard natural frequency which is a standard natural frequency of the healthy utility poles 30 belonging to the cluster, based on distribution information of the natural frequencies of each of the one or more healthy utility poles 30 belonging to the cluster. As a method of calculating a standard natural frequency of a certain cluster performed by the standard natural frequency calculation unit 217, for example, a method of calculating an average value, a median value, a mode value, or the like of the natural frequencies of one or more healthy utility poles 30 belonging to the certain cluster as the standard natural frequency and the like may be considered. However, the method of calculating the standard natural frequency is not limited to the above.

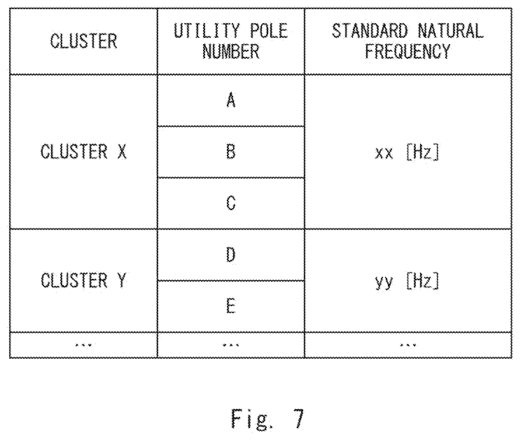

The standard natural frequency DB 218 is a database in which, for each cluster clustered by the clustering unit 216, the utility pole number of the utility pole 30 belonging to the cluster, the standard natural frequency of the cluster, and the like are registered. FIG. 7 illustrates an example of the contents of the standard natural frequency DB 218.

When analyzing the degradation state of a utility pole 30 to be analyzed, the clustering unit 216 determines the cluster to which the utility pole 30 to be analyzed belongs, based on the feature Top K of the utility pole 30 to be analyzed registered in the utility pole DB 215.

When analyzing the degradation state of a utility pole 30 to be analyzed, the degradation degree calculation unit 219 calculates the degradation degree of the utility pole 30 to be analyzed, based on the standard natural frequency of the cluster to which the utility pole 30 to be analyzed belongs and the natural frequency of the utility pole 30 to be analyzed. For example, the degradation degree calculation unit 219 calculates the degradation degree of the utility pole 30 to be analyzed using Equation 1 below.

$$Degradation degree = \vert 1 - \frac{Natural frequency}{Standard natural frequency} \vert \qquad [ Equation 1 ]$$

In addition, for each cluster clustered by the clustering unit 216, the degradation degree calculation unit 219 holds in advance a threshold value used for analysis of the degradation state of the utility pole 30 belonging to the cluster. The degradation degree calculation unit 219 compares the degradation degree of the utility pole 30 to be analyzed with the threshold value of the cluster to which the utility pole 30 to be analyzed belongs, using Equation 2 below. When the degradation degree exceeds the threshold value, the degradation degree calculation unit 219 analyzes that the utility pole 30 to be analyzed is degraded.

$$\vert 1 - \frac{Natural frequency}{Standard natural frequency} \vert > Threshold \qquad [ Equation 2 ]$$

Herein, the threshold value for each cluster may be statistically set based on the distribution information of the natural frequencies of the utility poles 30 belonging to the cluster. Alternatively, an analyst may analyze the actual utility pole 30 that has been analyzed to be degraded by the degradation degree calculation unit 219 and actually measure the actual degradation degree, and reflect the result of the actual measurement to the setting of the threshold value.

Further, the degradation degree calculation unit 219 may notify an alert when analyzing that the utility pole 30 to be analyzed is degraded. The notification destination of the alert may be, for example, a terminal owned by a monitor who monitors the utility pole 30 to be analyzed, a terminal installed in a monitoring center, or the like. The alert notification method may be, for example, a method of displaying a graphical user interface (GUI) screen on a display, a monitor, or the like of a terminal of the notification destination, or a method of vocally outputting a message from a speaker of a terminal of the notification destination.

Next, an operation of the utility pole degradation detection system according to the second example embodiment will be described.

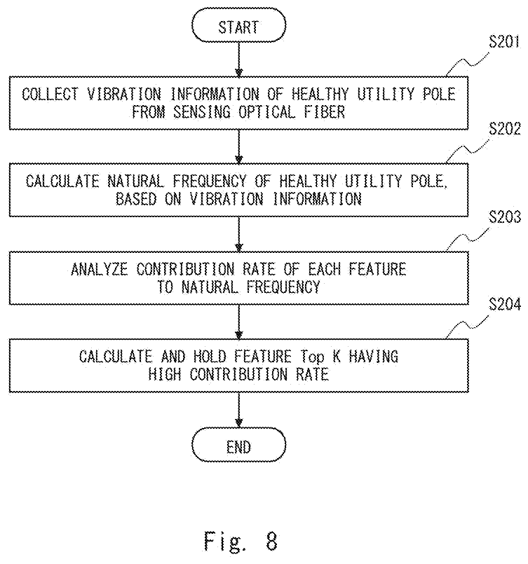

First, with reference to FIG. 8, an example of a flow of an operation of calculating the feature Top K having a high contribution ratio to the natural frequency will be described.

As illustrated in FIG. 8, first, the collecting unit 212 identifies a healthy utility pole 30 from among a plurality of utility poles 30 on which the sensing optical fiber 10 is laid, based on the health information registered in the utility pole DB 215. Herein, it is assumed that one or more healthy utility poles 30 are identified. The collecting unit 212 collects vibration information included in the return light generated in each of the one or more healthy utility poles 30, among the return lights received by the receiving unit 211 (step S201).

Then, the natural frequency calculation unit 213 calculates the natural frequency of each of the one or more healthy utility poles 30, based on the vibration information of each of the one or more healthy utility poles 30 collected by the collecting unit 212 (step S202).

Then, the contribution rate analysis unit 214 analyzes the contribution rates of features of a utility pole 30 registered in the utility pole DB 215 to the natural frequency, based on the natural frequency of each of the one or more healthy utility poles 30 calculated by the natural frequency calculation unit 213 and the features of each of the one or more healthy utility poles 30 registered in the utility pole DB 215 (step S203).

Thereafter, the contribution rate analysis unit 214 calculates a feature Top K having a high contribution rate to the natural frequency from the features of the utility pole 30, based on the analysis result of the contribution rate to the natural frequency of the features of the utility pole 30 registered in the utility pole DB 215, and holds the calculated feature Top K (step S204). The feature Top K may include only one feature, or may include a plurality of features.

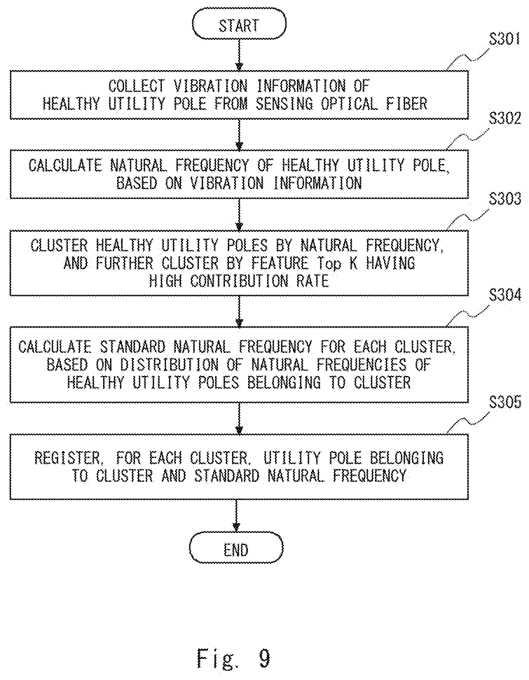

Next, with reference to FIG. 9, an example of a flow of an operation of calculating the standard natural frequency for each cluster will be described.

As illustrated in FIG. 9, first, steps S301 and S302 similar to steps S201 and S202 in FIG. 8 are performed.

Then, the clustering unit 216 first clusters one or more healthy utility poles 30 into clusters, based on the natural frequency calculated by the natural frequency calculation unit 213, and further clusters the clustered one or more healthy utility poles 30 into clusters, based on the feature Top K calculated by the contribution rate analysis unit 214 (step S303). At this time, the clustering unit 216 does not need to set the entire number of healthy utility poles 30 identified by the collecting unit 212 as a clustering target, and may set only a part of the healthy utility poles 30 as a clustering target.

Then, the standard natural frequency calculation unit 217 calculates, for each cluster clustered by the clustering unit 216, the standard natural frequency of the healthy utility poles 30 belonging to the cluster on the basis of the distribution information of the natural frequency of each of the one or more healthy utility poles 30 belonging to the cluster (step S304).

Thereafter, the clustering unit 216 registers, for each cluster clustered by the clustering unit 216, the utility pole number of each of the one or more healthy utility poles 30 belonging to the cluster in the standard natural frequency DB 218. Further, the standard natural frequency calculation unit 217 registers, for each cluster clustered by the clustering unit 216, the standard natural frequency of the cluster in the standard natural frequency DB 218 (step S305).

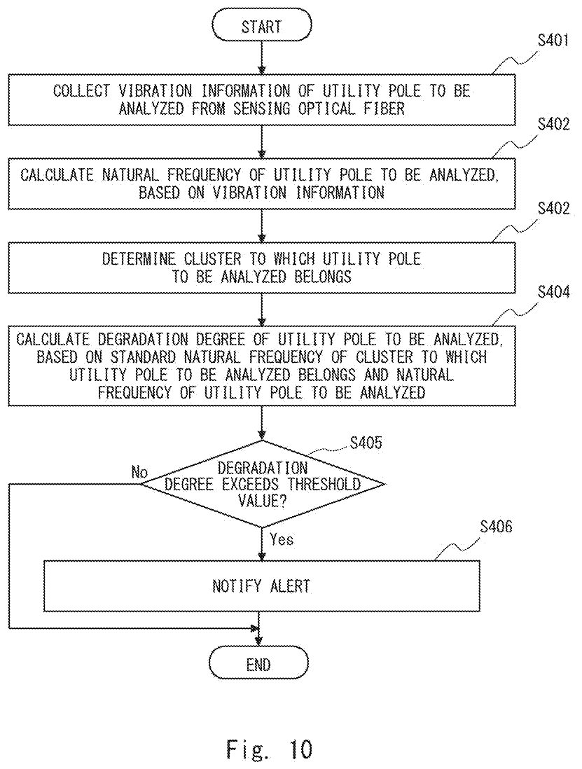

Next, with reference to FIG. 10, an example of a flow of an operation of analyzing the degradation state of a utility pole 30 to be analyzed will be described. Herein, description is made on the assumption that any number (or all) of utility poles 30 among the plurality of utility poles 30 on which the sensing optical fiber 10 is laid is set as an analysis target one by one, and the process of FIG. 10 is sequentially performed for one utility pole 30 that is to be analyzed.

As illustrated in FIG. 10, first, the collecting unit 212 collects vibration information included in a return light generated in the utility pole 30 to be analyzed, among the return lights received by the receiving unit 211 (step S401).

Then, the natural frequency calculation unit 213 calculates the natural frequency of the utility pole 30 to be analyzed, based on the vibration information of the utility pole 30 to be analyzed collected by the collecting unit 212 (step S402).

Then, the clustering unit 216 determines a cluster to which the utility pole 30 to be analyzed belongs, based on the feature Top K of the utility pole 30 to be analyzed registered in the utility pole DB 215 (step S403). However, for example, in the operation of FIG. 9, if the clustering of the utility pole 30 to be analyzed has been completed, the process of step S403 may be omitted.

Then, the degradation degree calculation unit 219 calculates the degradation degree of the utility pole 30 to be analyzed, based on the standard natural frequency of the cluster to which the utility pole 30 to be analyzed belongs, which is registered in the standard natural frequency DB 218, and the natural frequency of the utility pole 30 to be analyzed, which is calculated by the natural frequency calculation unit 213 (step S404).

Then, the degradation degree calculation unit 219 determines whether the degradation degree of the utility pole 30 to be analyzed exceeds the threshold value of the cluster to which the utility pole 30 to be analyzed belongs (step S405).

In step S405, when the degradation degree of the utility pole 30 to be analyzed exceeds the threshold value (Yes in step S405), the degradation degree calculation unit 219 analyzes that the utility pole 30 to be analyzed is degraded, and notifies an alert (step S406).

As described above, the process of FIG. 10 is completed for the utility pole 30 to be analyzed. Thereafter, the utility pole 30 to be analyzed is changed, and the process of FIG. 10 is performed on the changed utility pole 30. This operation is repeatedly performed for each of the number of utility poles 30 to be analyzed.

The analysis of the degradation state of any number of utility poles 30 may be performed every predetermined period, or may be performed when requested by a monitor or a monitoring center. The number of utility poles 30 to be analyzed may be set in advance, or may be specified by the monitor or the monitoring center.

It is preferable that the utility poles 30 to be analyzed belong to one cluster, but may belong to a plurality of clusters. When the utility poles 30 to be analyzed belong to a plurality of clusters, it is determined in step S403 that the cluster to which the utility poles 30 to be analyzed belong is a plurality of clusters. In this case, the processing of steps S404 to S406 may be performed for each of a plurality of clusters thereafter.

As described above, according to the second example embodiment, the natural frequency calculation unit 213 calculates the natural frequency of a healthy utility pole 30, based on the vibration information of the healthy utility pole 30, the clustering unit 216 clusters healthy utility poles 30 into clusters, and the standard natural frequency calculation unit 217 calculates, for each cluster, the standard natural frequency of the healthy utility poles 30 belonging to the cluster, based on the distribution information of the natural frequency of the healthy utility poles 30 belonging to the cluster. Therefore, the standard natural frequency can be calculated from the vibration information of the utility pole 30.

In addition, according to the second example embodiment, the natural frequency calculation unit 213 calculates the natural frequency of a utility pole 30 to be analyzed, based on the vibration information of the utility pole 30 to be analyzed, the clustering unit 216 determines the cluster to which the utility pole 30 to be analyzed belongs, and the degradation degree calculation unit 219 calculates the degradation degree of the utility pole 30 to be analyzed, based on the standard natural frequency of the cluster to which the utility pole 30 to be analyzed belongs and the natural frequency of the utility pole 30 to be analyzed. Therefore, the degradation state of the utility pole 30 can be detected with high accuracy.

Other effects are similar to those of the first example embodiment described above.

### Hardware Configuration of Utility Pole Degradation Detection Device According to Example Embodiments 1 and 2

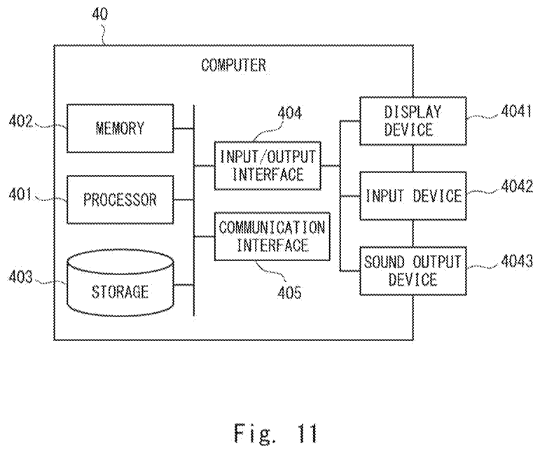

Next, with reference to FIG. 11, a hardware configuration of a computer 40 that implements the utility pole degradation detection devices 20 and 20A according to the first and second example embodiments described above will be described.

As illustrated in FIG. 11, the computer 40 includes a processor 401, a memory 402, a storage 403, an input/output interface (input/output I/F) 404, a communication interface (communication I/F) 405, and the like. The processor 401, the memory 402, the storage 403, the input/output interface 404, and the communication interface 405 are connected to each other via a data transmission path for transmitting and receiving data to and from each other.

The processor 401 is an arithmetic processing device such as, for example, a central processing unit (CPU) or a graphics processing unit (GPU). The memory 402 is a memory such as, for example, a random-access memory (RAM) or a read only memory (ROM). The storage 403 is a storage device such as, for example, a hard disk drive (HDD), a solid state drive (SSD), or a memory card. The storage 403 may be a memory such as a RAM or a ROM, as well.

The storage 403 stores a program for enabling the functions of the constituent elements included in the utility pole degradation detection devices 20 and 20A. The processor 401 executes the programs and thereby enables each of the functions of the constituent elements included in the utility pole degradation detection devices 20 and 20A. Herein, when executing the above-mentioned programs, the processor 401 may execute the programs after reading the programs onto the memory 402, or may execute the programs without reading the programs onto the memory 402. The memory 402 and the storage 403 also have a function of storing information and data held by the constituent elements included in the utility pole degradation detection devices 20 and 20A.

The programs described above may be stored using various types of non-transitory computer readable media, and may be supplied to a computer (including the computer 40). The non-transitory computer readable media include various types of tangible storage media. Examples of the non-transitory computer readable media include magnetic recording media (e.g., a flexible disk, a magnetic tape, and a hard disk drive), magneto-optical recording media (e.g., a magneto-optical disk), a compact disc-ROM (CD-ROM), a CD-Recordable (CD-R), a CD-rewritable (CD-R/W), a semiconductor memory (e.g., a mask ROM, a programmable ROM (PROM), an erasable PROM (EPROM), a flash ROM, and a RAM). The program may also be supplied to the computer by various types of transitory computer readable media. Examples of the transitory computer-readable media include electrical signals, optical signals, and electromagnetic waves. The transitory computer readable media are capable of supplying the program to the computer via a wired communication path or a wireless communication path, such as electrical wires and optical fibers.

The input/output interface 404 is connected to a display device 4041, an input device 4042, a sound output device 4043, and the like. The display device 4041 is a device for displaying a screen related to drawing data processed by the processor 401, such as a liquid crystal display (LCD), a cathode ray tube (CRT) display, or a monitor. The input device 4042 is a device for accepting an operation input made by an operator, and is, for example, a keyboard, a mouse, a touch sensor, or the like. The display device 4041 and the input device 4042 may be integrated and provided as a touch panel. The sound output device 4043 is a device, such as a speaker, for acoustically outputting a sound related to acoustic data processed by the processor 401.

The communication interface 405 transmits and receives data to and from an external device. For example, the communication interface 405 communicates with an external device via a wired communication path or a wireless communication path.

While the present disclosure has been particularly shown and described with reference to the embodiments thereof, the present disclosure is not limited to these embodiments. It will be understood by those of ordinary skill in the art that various changes in form and details may be made therein without departing from the spirit and scope of the present disclosure as defined by the claims.

For example, in the first and second example embodiments described above, a plurality of constituent elements are provided in the utility pole degradation detection devices 20 and 20A, but the present invention is not limited thereto. The constituent elements provided in the utility pole degradation detection devices 20 and 20A are not limited to being provided in one device, and may be provided in a distributed manner in a plurality of devices.

Further, in the first and second example embodiments described above, descriptions are made with an example of a case where a utility pole 30 is to be analyzed, but the present invention is not limited thereto. An object to be analyzed may be a structure such as a bridge, a tunnel, a pipe, or a dam. When such structures are to be analyzed, by laying sensing optical fibers 10 on a plurality of positions in the structures, it becomes possible to analyze a degradation state of each of the plurality of positions.

In addition, some or all of the above-described example embodiments may also be described as in the following Supplementary Notes, but are not limited to the following.

(Supplementary Note 1)

A utility pole degradation detection system comprising:

a sensing optical fiber laid on a plurality of utility poles;

a receiving unit configured to receive vibration information detected by the sensing optical fiber;

an identifying unit configured to identify a natural frequency of each of the plurality of utility poles, based on the vibration information; and

an analyzing unit configured to analyze a degradation state of at least one utility pole among the plurality of utility poles, based on a natural frequency of each of the plurality of utility poles.

(Supplementary Note 2)

The utility pole degradation detection system according to Supplementary Note 1, wherein the analyzing unit analyzes a degradation state of at least one utility pole among the plurality of utility poles, based on distribution information indicating a distribution of a natural frequency of each of the plurality of utility poles.

(Supplementary Note 3)

The utility pole degradation detection system according to Supplementary Note 2, wherein the analyzing unit clusters the plurality of utility poles into clusters, based on a feature of each of the plurality of utility poles, and analyzes, based on the distribution information of a natural frequency of each of one or more utility poles belonging to the same cluster, a degradation state of at least one utility pole belonging to the cluster.

(Supplementary Note 4)

The utility pole degradation detection system according to Supplementary Note 3, wherein the analyzing unit holds health information indicating healthiness of each of the plurality of utility poles, identifies a healthy utility pole from the plurality of utility poles, based on the health information, and analyzes, based on the distribution information of a natural frequency of each of one or more healthy utility poles belonging to the same cluster, a degradation state of at least one utility pole belonging to the cluster.

(Supplementary Note 5)

The utility pole degradation detection system according to Supplementary Note 4, wherein the analyzing unit calculates, based on the distribution information of a natural frequency of each of one or more healthy utility poles belonging to the same cluster, a standard natural frequency which is a standard natural frequency of a healthy utility pole belonging to the cluster, and analyzes, based on the standard natural frequency of the cluster and a natural frequency of a utility pole to be analyzed belonging to the cluster, a degradation state of the utility pole to be analyzed.

(Supplementary Note 6)

The utility pole degradation detection system according to any one of Supplementary Notes 3 to 5, wherein the analyzing unit identifies, from among features of the utility pole, a feature having a high contribution rate to a natural frequency of the utility pole, and clusters the plurality of utility poles into clusters, based on the identified feature of each of the plurality of utility poles.

(Supplementary Note 7)

A utility pole degradation detection method performed by a utility pole degradation detection system, comprising:

a receiving step of receiving vibration information detected by a sensing optical fiber laid on a plurality of utility poles;

an identifying step of identifying a natural frequency of each of the plurality of utility poles, based on the vibration information; and

an analyzing step of analyzing a degradation state of at least one utility pole among the plurality of utility poles, based on a natural frequency of each of the plurality of utility poles.

(Supplementary Note 8)

The utility pole degradation detection method according to Supplementary Note 7, wherein the analyzing step includes analyzing a degradation state of at least one utility pole among the plurality of utility poles, based on distribution information indicating a distribution of a natural frequency of each of the plurality of utility poles.

(Supplementary Note 9)

The utility pole degradation detection method according to Supplementary Note 8, wherein the analyzing step includes clustering the plurality of utility poles into clusters, based on a feature of each of the plurality of utility poles, and analyzing, based on the distribution information of a natural frequency of each of one or more utility poles belonging to the same cluster, a degradation state of at least one utility pole belonging to the cluster.

(Supplementary Note 10)

The utility pole degradation detection method according to Supplementary Note 9, wherein the analyzing step includes holding health information indicating healthiness of each of the plurality of utility poles, identifying a healthy utility pole from the plurality of utility poles, based on the health information, and analyzing, based on the distribution information of a natural frequency of each of one or more healthy utility poles belonging to the same cluster, a degradation state of at least one utility pole belonging to the cluster.

(Supplementary Note 11)

The utility pole degradation detection method according to Supplementary Note 10, wherein the analyzing step includes calculating, based on the distribution information of a natural frequency of each of one or more healthy utility poles belonging to the same cluster, a standard natural frequency which is a standard natural frequency of a healthy utility pole belonging to the cluster, and analyzing, based on the standard natural frequency of the cluster and a natural frequency of a utility pole to be analyzed belonging to the cluster, a degradation state of the utility pole to be analyzed.

(Supplementary Note 12)

The utility pole degradation detection method according to any one of Supplementary Notes 9 to 11, wherein the analyzing step includes identifying, from among features of the utility pole, a feature having a high contribution rate to a natural frequency of the utility pole, and clustering the plurality of utility poles into clusters, based on the identified feature of each of the plurality of utility poles.

(Supplementary Note 13)

A utility pole degradation detection device comprising:

a receiving unit configured to receive vibration information detected by a sensing optical fiber laid on a plurality of utility poles;

an identifying unit configured to identify a natural frequency of each of the plurality of utility poles, based on the vibration information; and

an analyzing unit configured to analyze a degradation state of at least one utility pole among the plurality of utility poles, based on a natural frequency of each of the plurality of utility poles.

### REFERENCE SIGNS LIST

10 Sensing optical fiber
20, 20A Utility pole degradation detection device
201 Receiving unit
202 Identifying unit
203 Analyzing unit
211 Receiving unit
212 Collecting unit
213 Natural frequency calculation unit
214 Contribution rate analysis unit
215 Utility pole DB
216 Clustering unit
217 Standard natural frequency calculation unit
218 Standard natural frequency DB
219 Degradation degree calculation unit
30 Utility pole
40 Computer
401 Processor
402 Memory
403 Storage
404 Input/output interface
4041 Display device
4042 Input device
4043 Sound output device
405 Communication interface

What is claimed is:

1. A utility pole degradation detection system comprising:
a sensing optical fiber laid on a plurality of utility poles;
a receiving unit configured to receive vibration information detected by the sensing optical fiber;
an identifying unit configured to identify a natural frequency of each of the plurality of utility poles, based on the vibration information; and
an analyzing unit configured to analyze a degradation state of at least one utility pole among the plurality of utility poles, based on a natural frequency of each of the plurality of utility poles.

2. The utility pole degradation detection system according to claim 1, wherein the analyzing unit analyzes a degradation state of at least one utility pole among the plurality of utility poles, based on distribution information indicating a distribution of a natural frequency of each of the plurality of utility poles.

3. The utility pole degradation detection system according to claim 2, wherein the analyzing unit clusters the plurality of utility poles into clusters, based on a feature of each of the plurality of utility poles, and analyzes, based on the distribution information of a natural frequency of each of one or more utility poles belonging to the same cluster, a degradation state of at least one utility pole belonging to the cluster.

4. The utility pole degradation detection system according to claim 3, wherein the analyzing unit holds health information indicating healthiness of each of the plurality of utility poles, identifies a healthy utility pole from the plurality of utility poles, based on the health information, and analyzes, based on the distribution information of a natural frequency of each of one or more healthy utility poles belonging to the same cluster, a degradation state of at least one utility pole belonging to the cluster.

5. The utility pole degradation detection system according to claim 4, wherein the analyzing unit calculates, based on the distribution information of a natural frequency of each of one or more healthy utility poles belonging to the same cluster, a standard natural frequency which is a standard natural frequency of a healthy utility pole belonging to the cluster, and analyzes, based on the standard natural frequency of the cluster and a natural frequency of a utility pole to be analyzed belonging to the cluster, a degradation state of the utility pole to be analyzed.

6. The utility pole degradation detection system according to claim 3, wherein the analyzing unit identifies, from among features of the utility pole, a feature having a high contribution rate to a natural frequency of the utility pole, and clusters the plurality of utility poles into clusters, based on the identified feature of each of the plurality of utility poles.

7. A utility pole degradation detection method performed by a utility pole degradation detection system, comprising:
a receiving step of receiving vibration information detected by a sensing optical fiber laid on a plurality of utility poles;
an identifying step of identifying a natural frequency of each of the plurality of utility poles, based on the vibration information; and
an analyzing step of analyzing a degradation state of at least one utility pole among the plurality of utility poles, based on a natural frequency of each of the plurality of utility poles.

8. The utility pole degradation detection method according to claim 7, wherein the analyzing step includes analyzing a degradation state of at least one utility pole among the plurality of utility poles, based on distribution information indicating a distribution of a natural frequency of each of the plurality of utility poles.

9. The utility pole degradation detection method according to claim 8, wherein the analyzing step includes clustering the plurality of utility poles into clusters, based on a feature of each of the plurality of utility poles, and analyzing, based on the distribution information of a natural frequency of each of one or more utility poles belonging to the same cluster, a degradation state of at least one utility pole belonging to the cluster.

10. The utility pole degradation detection method according to claim 9, wherein the analyzing step includes holding health information indicating healthiness of each of the plurality of utility poles, identifying a healthy utility pole from the plurality of utility poles, based on the health information, and analyzing, based on the distribution information of a natural frequency of each of one or more healthy utility poles belonging to the same cluster, a degradation state of at least one utility pole belonging to the cluster.

11. The utility pole degradation detection method according to claim 10, wherein the analyzing step includes calculating, based on the distribution information of a natural frequency of each of one or more healthy utility poles belonging to the same cluster, a standard natural frequency which is a standard natural frequency of a healthy utility pole belonging to the cluster, and analyzing, based on the standard natural frequency of the cluster and a natural frequency of a utility pole to be analyzed belonging to the cluster, a degradation state of the utility pole to be analyzed.

12. The utility pole degradation detection method according to claim 9, wherein the analyzing step includes identifying, from among features of the utility pole, a feature having a high contribution rate to a natural frequency of the utility pole, and clustering the plurality of utility poles into clusters, based on the identified feature of each of the plurality of utility poles.

13. A utility pole degradation detection device comprising:
a receiving unit configured to receive vibration information detected by a sensing optical fiber laid on a plurality of utility poles;
an identifying unit configured to identify a natural frequency of each of the plurality of utility poles, based on the vibration information; and
an analyzing unit configured to analyze a degradation state of at least one utility pole among the plurality of utility poles, based on a natural frequency of each of the plurality of utility poles.
